(19) United States
(12) Patent Application Publication
(10) Pub. No.: US 2009/0244308 A1
(43) Pub. Date: Oct. 1, 2009

(54) Image Inclination Correction Device and Image Inclination Correction Method

(76) Inventor: Yukio Mori, Osaka (JP)

Correspondence Address: NDQ&M WATCHSTONE LLP, 1300 EYE STREET, NW, SUITE 1000 WEST TOWER, WASHINGTON, DC, 20005, US

(21) Appl. No.: 12/300,687

(22) PCT Filed: May 2, 2007
(86) PCT No.: PCT/JP2007/059365

§ 371 Date: Nov. 13, 2008

(30) Foreign Application Priority Data
May 15, 2006 (JP) 2006-135352

(51) Int. Cl. H04N 5/228; G06K 9/36

(52) U.S. Cl. 348/222.1; 382/289; 348/E05.031

(57) ABSTRACT

An original image obtained by imaging and a rotated image obtained by rotating the original image are made to be evaluation images. For each of the evaluation images, an inclination of the evaluation image with respect to an axis parallel to a plumb line in the image is evaluated. According to the evaluation result, the original image is rotated/corrected so as to reduce the inclination. More specifically, the horizontal edge components of the evaluation image are calculated in a matrix state and the magnitudes of the horizontal edge components are projected in a vertical direction so as to calculate a vertically projected value Q_{V}[n]. The original image is rotated/corrected in the direction to increase the magnitude of the horizontal-direction high-hand component of the vertical projection value Q_{V}[n]. The same applies when a horizontally projected value Q_{H}[m] corresponding to vertical edge components is used.

### TECHNICAL FIELD

The present invention relates to an image inclination correction device and an image inclination correction method for correcting an inclination of an image shot with an image shooting apparatus such as a digital still camera, digital video camera, or the like. The present invention also relates to an image shooting apparatus provided with such an image inclination correction device.

### BACKGROUND ART

When a subject is shot with an image shooting apparatus such as a digital still camera, digital video camera, or the like, excessive attention to the subject may cause the shot image to incline. In particular, in a case where a moving image is shot, during shooting, the image shooting apparatus often inclines inadvertently, causing the shot image to incline.

Such an inclination of an image is often first noticed, for example, when the image is played back on an image shooting apparatus, personal computer, or television apparatus, or after the image is printed. In such a case, it is too late to reshoot the image. Moreover, in general, an inclined image is not good-looking, and is not fit for recording on a recording medium.

For correction of such inclinations, there have been proposed methods involving fitting an image shooting apparatus with, for example, an inclination sensor for detecting the inclination of the image shooting apparatus (e.g. see Patent Document 1 listed below).

Patent Document 1: JP-A-2005-348212

### DISCLOSURE OF THE INVENTION

### Problems to be Solved by the Invention

Inconveniently, fitting an image shooting apparatus with an inclination sensor for detecting its inclination necessarily makes the image shooting apparatus larger and more expensive.

In view of the foregoing, it is an object of the present invention to provide an image inclination correction device that can correct an inclination of a shot image without use of an inclination sensor or the like, and to provide an image shooting apparatus provided with such an image inclination correction device. It is another object of the present invention to provide an image inclination correction method that can correct an inclination of a shot image without use of an inclination sensor or the like.

### Means for Solving the Problem

To achieve the above objects, according to the present invention, an image inclination correction device is provided with: an image rotating portion that outputs a rotated image by changing the inclination of a shot image obtained by an image sensing portion; and an inclination evaluating portion that takes the rotated image as an evaluation image and evaluates the inclination of the evaluation image relative to a predetermined axis based on the shot-image signal representing the shot image. Here, the image inclination correction device outputs, based on the evaluation result yielded by the inclination evaluating portion, an inclination-corrected image obtained by rotation-correcting the inclination of the shot image relative to the predetermined axis.

Based on the shot-image signal, the inclination of the shot image is evaluated and, based on the result of the evaluation, rotation correction is performed. Thus, there is no need for an inclination sensor or the like. The predetermined axis here means, for example, an “axis parallel to the plumb line” as assumed in the shot image or the evaluation image. The predetermined axis may be grasped as an arbitrary axis that is automatically determined as an “axis parallel to the plumb line” is determined. For example, it may be grasped as an “axis parallel to the horizon line” as assumed in the shot image or the evaluation image.

Specifically, for example, the inclination evaluating portion evaluates the inclination of the evaluation image based on at least one of a horizontal edge component and a vertical edge component of the evaluation image.

For example, the inclination evaluating portion is provided with: a horizontal edge component calculating portion that calculates horizontal edge components of the evaluation image in the form of a matrix; and a vertically projecting portion that projects the magnitudes of the calculated horizontal edge components in the vertical direction to calculate vertically projected values. The image inclination correction device then produces the inclination-corrected image by rotation-correcting the shot image in the direction in which the magnitudes of horizontal-direction high-band components of the vertically projected values increase.

For example, the inclination evaluating portion is provided with: a vertical edge component calculating portion that calculates vertical edge components of the evaluation image in the form of a matrix; and a horizontally projecting portion that projects the magnitudes of the calculated vertical edge components in the horizontal direction to calculate horizontally projected values. The image inclination correction device then produces the inclination-corrected image by rotation-correcting the shot image in the direction in which the magnitudes of vertical-direction high-band components of the horizontally projected values increase.

For example, the inclination evaluating portion is provided with: a vertical evaluation value calculating portion comprising a horizontal edge component calculating portion that calculates horizontal edge components of the evaluation image in the form of a matrix, and a vertically projecting portion that projects the magnitudes of the calculated horizontal edge components in the vertical direction to calculate vertically projected values, the vertical evaluation value calculating portion calculating a vertical evaluation value by summing up the magnitudes of horizontal-direction high-band components of the vertically projected values; and a horizontal evaluation value calculating portion comprising a vertical edge component calculating portion that calculates vertical edge components of the evaluation image in the form of a matrix, and a horizontally projecting portion that projects the magnitudes of the calculated vertical edge components in the horizontal direction to calculate horizontally projected values, the horizontal evaluation value calculating portion calculating a horizontal evaluation value by summing up the magnitudes of vertical-direction high-band components of the horizontally projected values. The image inclination correction device then determines the inclination-corrected image based on at least one of the vertical evaluation value and the horizontal evaluation value.

Before the processing by the horizontal edge component calculating portion and/or the vertical edge component calculating portion, any other processing may be inserted.

For example, the vertical evaluation value calculating portion may be further provided with a vertical smoothing portion that performs smoothing processing on the evaluation image in the vertical direction, so that the horizontal edge component calculating portion calculates the horizontal edge components in the evaluation image after the smoothing processing by the vertical smoothing portion; the horizontal evaluation value calculating portion may be further provided with a horizontal smoothing portion that performs smoothing processing on the evaluation image in the horizontal direction, so that the vertical edge component calculating portion calculates the vertical edge components in the evaluation image after the smoothing processing by the horizontal smoothing portion.

For example, the inclination evaluating portion may be provided with: a vertical evaluation value calculating portion comprising a vertically projecting portion that projects brightness values of the evaluation image in the vertical direction to calculate vertically projected values, the vertical evaluation value calculating portion calculating the vertical evaluation value by summing up the magnitudes of horizontal-direction high-band components of the vertically projected values; and a horizontal evaluation value calculating portion comprising a horizontally projecting portion that projects brightness values of the evaluation image in the horizontal direction to calculate horizontally projected values, the horizontal evaluation value calculating portion calculating the horizontal evaluation value by summing up the magnitudes of vertical-direction high-band components of the horizontally projected values. The image inclination correction device then determines the inclination-corrected image based on at least one of the vertical evaluation value and the horizontal evaluation value.

For example, the image inclination correction device may determine the inclination-corrected image based on the result of adding up the vertical evaluation value and the horizontal evaluation value in a predetermined ratio.

Alternatively, for example, the image inclination correction device may choose one of the vertical evaluation value and the horizontal evaluation value through comparison processing using the vertical evaluation value and the horizontal evaluation value to determine, based on the chosen evaluation value, the inclination-corrected image.

For example, the rotated image is formed as an image within a rectangular region lying inside the shot image before being rotated and having an aspect ratio commensurate with the aspect ratio of the shot image.

Preferably, an image shooting apparatus is provided with any one of the image inclination correction devices described above in combination with image sensing portion.

To achieve the above objects, according to the present invention, an image inclination correction method includes: taking as an evaluation image a rotated image obtained by changing the inclination of a shot image obtained by an image sensing portion, and evaluating the inclination of the evaluation image relative to a predetermined axis based on the shot-image signal representing the shot image; and rotation-correcting, based on the result of the evaluation, the inclination of the shot image relative to the predetermined axis.

For example, in the image inclination correction method described above, the inclination of the evaluation image is evaluated based on at least one of a horizontal edge component and a vertical edge component of the evaluation image.

### ADVANTAGES OF THE INVENTION

According to the present invention, it is possible to correct an inclination of a shot image without provision of an inclination sensor or the like.

### BRIEF DESCRIPTION OF DRAWINGS

FIG. 1 An overall block diagram of an image shooting apparatus embodying the present invention.

FIG. 2 An internal configuration diagram of the image sensing portion in FIG. 1.

FIG. 3 Examples of images shot with the image shooting apparatus of FIG. 1.

FIG. 4 A configuration block diagram for achieving an inclination correction function in the image shooting apparatus of FIG. 1.

FIG. 5 A diagram illustrating a rotated image generated by the image rotation portion in FIG. 4.

FIG. 6 A diagram illustrating a rotated image generated by the image rotation portion in FIG. 4.

FIG. 7 A diagram showing the array of pixels in an original or rotated image in the image shooting apparatus of FIG. 1.

FIG. 8 A diagram showing the Y signals corresponding to the pixels in FIG. 7.

FIG. 9 A diagram illustrating a rotated image generated by the image rotation portion in FIG. 4.

FIG. 10 An internal block diagram of the inclination evaluation portion in FIG. 4.

FIG. 11 A diagram showing an example of a filter used, for example, in the horizontal edge extraction portion in FIG. 10.

FIG. 12 A diagram showing an example of a filter used, for example, in the vertical edge extraction portion in FIG. 10.

FIG. 13 A diagram showing the relationship between step edges in an evaluation image and vertically projected values calculated by the vertical projection portion in FIG. 10.

FIG. 14 A diagram illustrating the relationship among an evaluation image, vertically projected values, and horizontally projected values.

FIG. 15 A flow chart showing the inclination correction procedure performed by the inclination correction portion in FIG. 1 during moving image shooting.

FIG. 16 A flow chart showing the inclination correction procedure performed by the inclination correction portion in FIG. 1 during still image shooting.

FIG. 17 A diagram showing a modified example of the inclination evaluation portion in FIG. 10.

FIG. 18 A diagram showing a modified example of the inclination evaluation portion in FIG. 10.

### LIST OF REFERENCE SYMBOLS

1 Image Shooting Apparatus
11 Image Sensing Portion
12 AFE
13 Video Signal Processing Portion
17 DRAM
40 Inclination Correction Portion
43 Image Rotation Portion
44, 44a, 44b Inclination Evaluation Portion
45a Vertical LPF
45b Horizontal LPF
46a Horizontal Edge Extraction Portion
46b Vertical Edge Extraction Portion
47a, 51a Vertical Projection Portion
47b, 51b Horizontal Projection Portion
48a, 48b, 52a, 52b High-band Component Summation Portion
49 Inclination Evaluation Value Calculation Portion

### BEST MODE FOR CARRYING OUT THE INVENTION

Hereinafter, embodiments of the present invention will be described specifically with reference to the accompanying drawings. Among the different drawings referred to in the course of description, the same parts are identified by common reference signs.

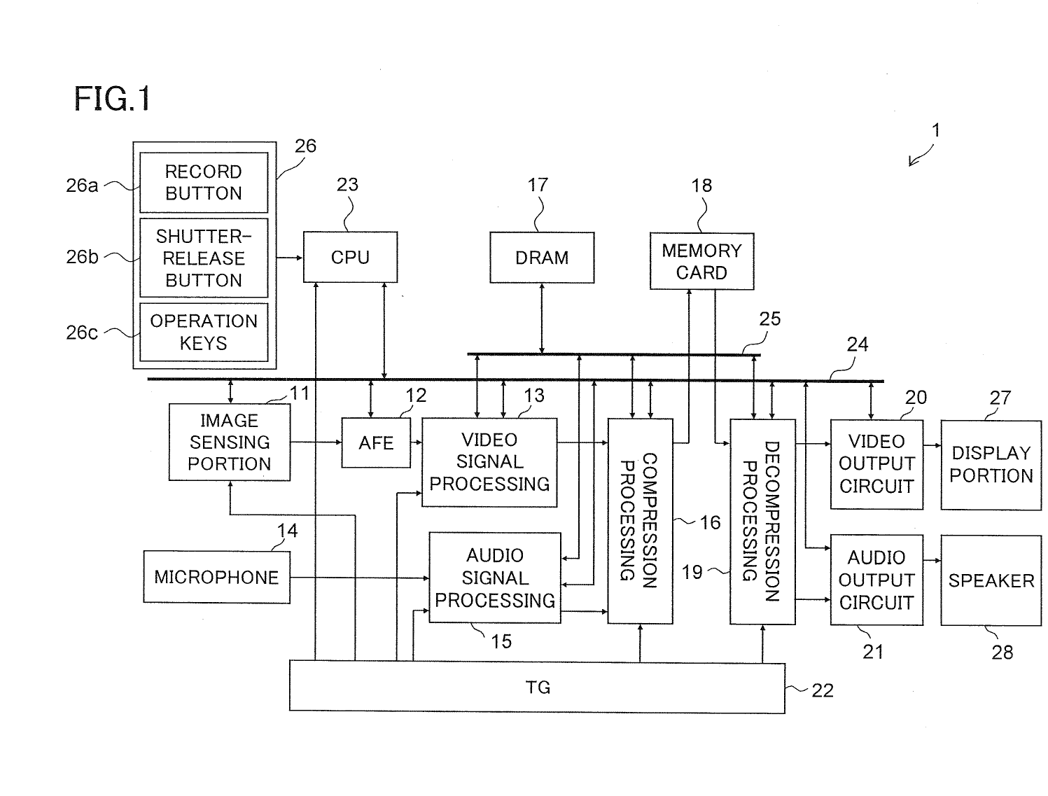

FIG. 1 is an overall block diagram of an image shooting apparatus 1 embodying the present invention. The image shooting apparatus 1 is, for example, a digital still camera or digital video camera. The image shooting apparatus 1 is capable of shooting moving image and still images, and is capable of shooting still images concurrently with shooting of a moving image.

The image shooting apparatus 1 is provided with an image sensing portion 11, an AFE (analog front end) 12, a video signal processing portion 13, a microphone 14, an audio signal processing portion 15, a compression processing portion 16, a DRAM (dynamic random access memory) 17 as an example of an internal memory, a memory card 18, a decompression processing portion 19, a video output circuit 20, an audio output circuit 21, a TG (timing generator) 22, a CPU (central processing unit) 23, a bus 24, a bus 25, an operation portion 26, a display portion (playback means) 27, and a speaker 28. The operation portion 26 has a record button 26a, a shutter-release button 26b, operation keys 26c, etc.

Connected to the bus 24 are the image sensing portion 11, the AFE 12, the video signal processing portion 13, the audio signal processing portion 15, the compression processing portion 16, the decompression processing portion 19, the video output circuit 20, the audio output circuit 21, and the CPU 23. These blocks connected to the bus 24 exchange various signals (various kinds of data) via the bus 24.

Connected to the bus 25 are the video signal processing portion 13, the audio signal processing portion 15, the compression processing portion 16, the decompression processing portion 19, and the DRAM 17. These blocks connected to the bus 25 exchange various signals (various kinds of data) via the bus 25.

The TG 22 generates timing control signals for controlling the timing of different operations in the entire image shooting apparatus 1, and feeds the generated timing control signal to different blocks in the image shooting apparatus 1. Specifically, the timing control signals are fed to the image sensing portion 11, the video signal processing portion 13, the audio signal processing portion 15, the compression processing portion 16, the decompression processing portion 19, and the CPU 23. The timing control signals include a vertical synchronizing signal Vsync and a horizontal synchronizing signal Hsync.

The CPU 23 controls the operation of different blocks in the image shooting apparatus 1 in a centralized fashion. The operation portion 26 accepts operation done by a user. The contents of operation done on the operation portion 26 are transmitted to the CPU 23. The DRAM 17 functions as a frame memory. As necessary, different blocks in the image shooting apparatus 1 temporarily record various kinds of data (digital signals) to the DRAM 17.

The memory card 18 is an external recording medium, and is, for example, an SD (Secure Digital) memory card. The memory card 18 is detachably attached to the image shooting apparatus 1. The contents recorded in the memory card 18 can be freely read out by an external personal computer or the like via the terminals of the memory card 18 or via a connector portion (unillustrated) for communication that is provided in the image shooting apparatus 1. Although a memory card 18 is taken up as an example of an external recording medium in this embodiment, the external recording medium may be composed of one or more recording media that permit random access (such as semiconductor memory, memory card, optical disc, magnetic disc, etc.).

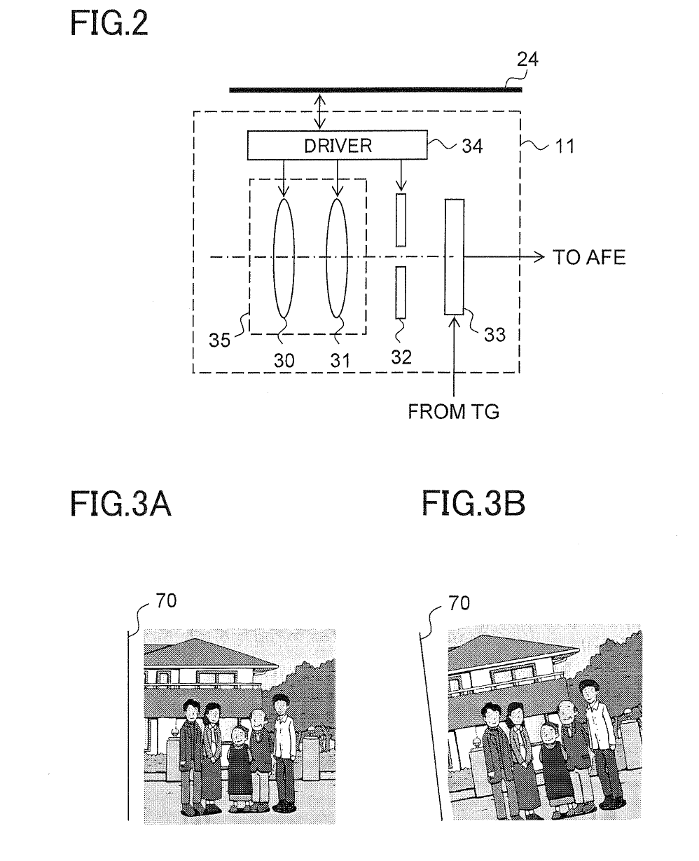

FIG. 2 is an internal configuration diagram of the image sensing portion 11 in FIG. 1. The image sensing portion 11 has an optical system 35 composed of a plurality of lenses including a zoom lens 30 and a focus lens 31, an aperture stop 32, an image sensing device 33, and a driver 34. The driver 34 is composed of motors etc. for achieving movement of the zoom lens 30 and the focus lens 31 and adjustment of the aperture size of the aperture stop 12.

The light from a subject (shooting target) is incident on the image sensing device 33 through the zoom lens 30 and the focus lens 31, which are provided in the optical system 35, and through the aperture stop 32. The TG 22 generates drive pulses for driving the image sensing device 33 that are synchronous with the timing control signals mentioned above, and feeds the drive pulses to the image sensing device 33.

The image sensing device 33 is, for example, a CCD (charge-coupled device) or CMOS (complementary metal oxide semiconductor) image sensor or the like. The image sensing device 33 performs photoelectric conversion on the optical image incident through the optical system 35 and the aperture stop 32, and outputs an electric signal obtained through the photoelectric conversion to the AFE 12. More specifically, the image sensing device 33 is provided with a plurality of pixels (light-receiving pixels, unillustrated) arrayed in a two-dimensional matrix, each pixel accumulating a signal charge with an amount of electric charge commensurate with the duration of its exposure during each period of shooting. Having levels proportional to the amounts of charge of the signal charges thus accumulated, the electric signals from the individual pixels are sequentially outputted, in synchronism with the drive pulses from the TG 22, to the AFE 12 in the following stage.

The image sensing device 33 is a single-panel image sensing device capable of color shooting. The pixels composing the image sensing device 33 are each provided with, for example, a red (R), green (G), or blue (B) color filter (unillustrated). As the image sensing device 33, a three-panel image sensing device may instead be adopted.

The AFE 12 is provided with: an amplifier circuit (unillustrated) that amplifies the above-mentioned analog electric signals that are the output signals of the image sensing portion 11 (i.e. the output signals of the image sensing device 33); and an A/D (analog-to-digital) conversion circuit (unillustrated) that converts the amplified signals into digital signals. The output signals of the image sensing portion 11 as converted into digital signals by the AFE 12 are sequentially fed to the video signal processing portion 13. The CPU 23 adjusts the amplification factor of the amplifier circuit based on the signal level of the output signals of the image sensing portion 11.

In the following description, the signals outputted from the image sensing portion 11 or the AFE 12 according to the subject will be called the shot-image signal.

Based on the shot-image signal from the AFE 12, the video signal processing portion 13 generates a video signal representing the shot image (video) obtained through shooting by the image sensing portion 11, and feeds the generated video signal to the compression processing portion 16. The video signal is composed of a luminance signal Y representing the brightness of the shot image and color difference signals U and V representing the color of the shot image.

The microphone 14 converts sounds (sound waves) fed in from outside into an analog electric signal and outputs it. The audio signal processing portion 15 converts the electric signal (analog audio signal) outputted from the microphone 14 into a digital signal. The digital signal obtained through this conversion is fed, as an audio signal representing the sounds inputted to the microphone 14, to the compression processing portion 16.

The compression processing portion 16 compresses the video signal from the video signal processing portion 13 by use of a predetermined compression method such as MPEG (Moving image Experts Group) or JPEG (Joint Photographic Experts Group). In moving or still image shooting, the compressed video signal is fed to the memory card 18. The compression processing portion 16 also compresses the audio signal from the audio signal processing portion 15 by use of a predetermined compression method such as AAC (Advanced Audio Coding). In moving image shooting, the video signal from the video signal processing portion 13 and the audio signal from the audio signal processing portion 15 are compressed by the compression processing portion 16 while they are temporally associated with each other, and after the compression they are fed to the memory card 18.

The record button 26a is a push button switch by which the user requests starting and ending of shooting of a moving image (moving picture), and the shutter-release button 26b is a push button switch by which the user requests shooting of a still image (still picture). According to operation done with the record button 26a, starting and ending of moving image shooting are effected, and, according to operation done with the shutter-release button 26b, still image shooting is effected. For one frame, one frame image is obtained. The duration of each frame is, for example, 1/60 seconds. In this case, a series of frame images (stream of images) sequentially obtained at a cycle of 1/60 seconds form a moving image.

The image shooting apparatus 1 operates in different operation modes, which include: shooting mode, in which moving and still images can be shot; and playback mode, in which moving or still images stored in the memory card 18 are played back and displayed on the display portion 27. According to operation done with the operation keys 26c, the different modes are switched.

In shooting mode, when the user presses the record button 26a, under the control of the CPU 23, the video signal of one frame after another after button pressing is, along with the corresponding audio signal, recorded to the memory card 18 via the compression processing portion 16. That is, along with the audio signal, the shot image (i.e. frame image) of one frame after another is stored in the memory card 18. After the start of moving image shooting, when the user presses the record button 26a again, moving image shooting is ended. That is, recording of the video signal and the audio signal to the memory card 18 is ended, and shooting of one moving image is completed.

On the other hand, in shooting mode, when the user presses the shutter-release button 26b, shooting of a still image is performed. Specifically, under the control of the CPU 23, the video signal of one frame immediately after button pressing is, as a video signal representing a still image, recorded to the memory card 18 via the compression processing portion 16.

In playback mode, when the user does predetermined operation with the operation keys 26c, the compressed video signal representing a moving or still image recorded in the memory card 18 is fed to the decompression processing portion 19. The decompression processing portion 19 decompresses the received video signal and feeds the result to the video output circuit 20. Moreover, in shooting mode, normally, irrespective of whether or not a moving or still image is currently being shot, the video signal processing portion 13 keeps generating the video signal, which is kept being fed to the video output circuit 20.

The video output circuit 20 converts the digital video signal fed to it into a video signal (e.g. an analog video signal) of a format that can be displayed on the display portion 27 and outputs the result. The display portion 27 is a display device such as a liquid crystal display, and displays an image according to the video signal outputted from the video output circuit 20. That is, the display portion 27 displays an image (an image representing the current subject) based on the shot-image signal currently being outputted from the image sensing portion 11, or a moving image (moving picture) or still image (still picture) recorded in the memory card 18.

When a moving image is played back in the playback mode, the compressed audio signal corresponding to the moving image recorded in the memory card 18 is fed to the decompression processing portion 19 as well. The decompression processing portion 19 decompresses the received audio signal and feeds the result to the audio output circuit 21. The audio output circuit 21 converts the digital audio signal fed to it into an audio signal (e.g. an analog audio signal) of a format that can be outputted on the speaker 28 and outputs the result to the speaker 28. The speaker 28 outputs the audio signal from the audio output circuit 21 to outside in the form of sounds (sound waves).

The video signal processing portion 13 includes: an AF evaluation value detection circuit that detects an AF evaluation value commensurate with the amount of contrast within a focus detection region in the shot image; an AE evaluation value detection circuit that detects an AE evaluation value commensurate with the brightness of the shot image; a motion detection circuit that detects motion in the image; etc. (of which none is illustrated). According to the AF evaluation value, the CPU 23 adjusts the position of the focus lens 31 via the driver 34 in FIG. 2, and thereby focuses an optical image of the subject on the image sensing surface (light receiving surface) of the image sensing device 33. Moreover, according to the AE evaluation value, the CPU 23 adjusts the aperture size of the aperture stop 32 via the driver 34 in FIG. 2 (and the amplification factor of the amplifier circuit in the AFE 12), and thereby controls the amount of light received (the brightness of the image). The video signal processing portion 13 also generates thumbnail images.

FIGS. 3A and 3B show examples of shot images. In FIGS. 3A and 3B, the axis 70 is an “axis parallel to the plumb line” as assumed in a shot image (and also in a rotated image, which will be described later). Whereas the vertical direction of the shot image shown in FIG. 3A is parallel to the axis 70, the vertical direction of the shot image shown in FIG. 3B is not parallel to the axis 70. That is, whereas the shot image shown in FIG. 3A is not inclined relative to the axis 70, the shot image shown in FIG. 3B is inclined relative to the axis 70. The image shooting apparatus 1 of FIG. 1 is provided with an inclination correction function for correcting such an inclination of a shot image.

In the present specification, unless otherwise stated, “inclination” means the inclination of the vertical direction of an image relative to an “axis parallel to the plumb line” as assumed in the image. The concept of “image” here includes “evaluation images”, which will be described later. Needless to say, such an inclination is equivalent to the inclination of the horizontal direction of the same image relative to an “axis parallel to the horizon line” as assumed in the image.

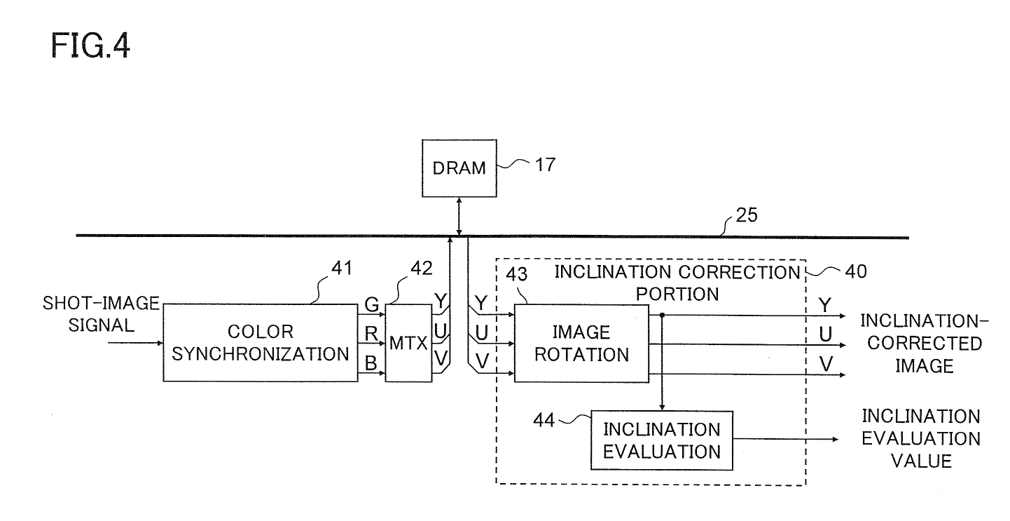

A configuration block diagram for achieving the inclination correction function is shown in FIG. 4. The inclination correction function is achieved mainly by an inclination correction portion 40 in FIG. 4. The inclination correction portion 40 is provided with an image rotation portion 43 and an inclination evaluation portion 44. The inclination correction portion 40, a color synchronization portion 41, and an MTX circuit 42, which are all shown in FIG. 4, are provided in the video signal processing portion 13 in FIG. 1.

The color synchronization portion 41 performs so-called color synchronization on the shot-image signal fed from the AFE 12, and thereby generates a G signal, an R signal, and a B signal for each of the pixels composing the shot image. The MTX circuit 42 converts the G, R, and B signals generated by the color synchronization portion 41 into a luminance signal Y and color difference signals U and V through matrix calculation. The luminance signal Y and the color difference signals U and V obtained through this conversion are written to the DRAM 17. In the following description, the luminance signal Y and the color difference signals U and V will be called the Y signal, the U signal, and the V signal respectively.

The image rotation portion 43 reads out the Y, U, and V signals representing the shot image from the DRAM 17; it then rotates the shot image to generate a rotated image, and outputs Y, U, and V signals representing this rotated image. The image rotation portion 43 can also output the Y, U, and V signals of the unrotated image, that is, the shot image itself. In a case where the Y, U, and V signals representing the shot image itself are outputted, the output signals of the MTX circuit 42 or the signals read out from the DRAM 17 may be fed intact, without passage through the image rotation portion 43, to the block (such as the inclination evaluation portion 44) that needs them.

In the following description, the shot image itself that has not undergone rotation processing by the image rotation portion 43 will be specifically called the “original image”.

Based on the Y signal of the rotated image outputted from the image rotation portion 43, the inclination evaluation portion 44 calculates an inclination evaluation value that serves as an indicator of the inclination of the rotated image. Moreover, based on the Y signal of the original image, the inclination evaluation portion 44 calculates an inclination evaluation value that serves as an indicator of the inclination of the original image. The calculated inclination evaluation values are fed to, for example, the CPU 23, which then performs appropriate inclination correction based on those inclination evaluation values.

As will be described in more detail later, the inclination evaluation value is a value commensurate with the inclination of the original or rotated image, and is usually the greater the closer the inclination is to zero.

Accordingly, in moving image shooting, for example, the CPU 23 controls, by use of so-called hill-climbing control, the rotation angle of the rotation of the image by the image rotation portion 43 such that the inclination evaluation value is constantly kept in the neighborhood of its maximum value. The inclination correction portion 40 then outputs the rotated image obtained through such rotation (or, in some cases, the original image itself) as an inclination-corrected image. On the other hand, in still image shooting, the CPU 23 calculates the rotation angle of the rotation that permits the inclination evaluation value to take its maximum value, and outputs the rotated image obtained through such rotation (or, in some cases, the original image itself) as an inclination-corrected image. These procedures will be described in detail later.

### [Generation of Rotated Image]

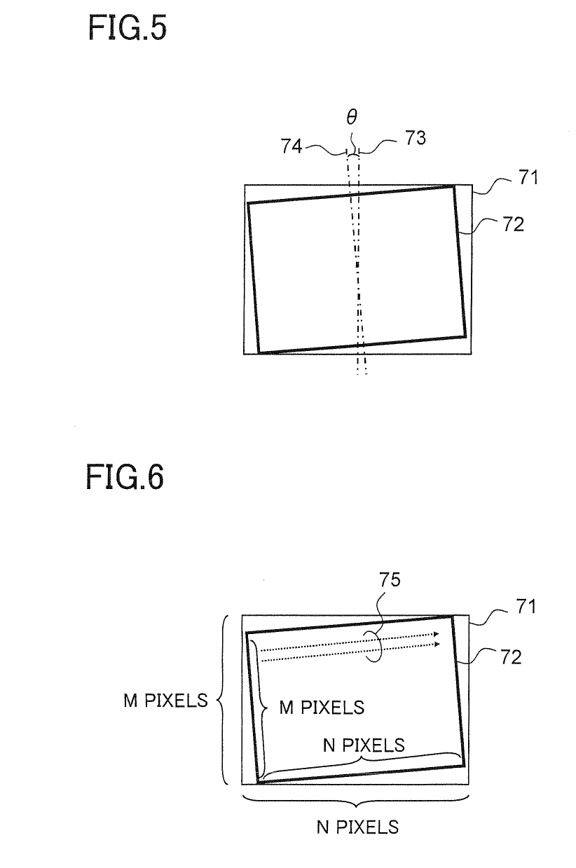

First, with reference to FIG. 5, how the image rotation portion 43 generates a rotated image will be described. In FIG. 5, the reference sign 71 represents an original image having a rectangular image shape, and the reference sign 72 represents a rotated image obtained from the original image 71. The rotated image 72 corresponds to an image obtained by cutting out a central portion of the image obtained by rotating the original image 71 through an angle of θ with the center of rotation at the center of the original image 71. FIG. 5 shows a case where the original image 71 is rotated through an angle of θ counter-clockwise. In the following description, the angle θ will be called the rotation angle θ.

The image shape of the original image 71 and the image shape of the rotated image 72 are in a geometrically similar relationship. Thus the aspect ratios of the image shapes of the original image 71 and the rotated image 72 are equal. These aspect ratios simply need to be approximately equal, and do not need to be precisely equal (i.e. they have simply to be substantially equal). The straight line 73 connecting the midpoints of the longer sides of the rectangular as the image shape of the original image 71 and the straight line 74 connecting the midpoints of the longer sides of the rectangular as the image shape of the rotated image 72 intersect at the rotation angle θ.

Moreover, the rotated image 72 lies inside the original image 71. That is, the rectangular that indicates the image shape of the rotated image 72 lies inside the rectangular that indicates the image shape of the original image 71. Here it is preferable to make the rotated image 72 as large as possible (i.e. so that it has its maximum size).

As shown in FIG. 6, the original image 71 is a two-dimensional image with (M×N) pixels arrayed in a matrix. The original image 71 is composed of an array of horizontally N and vertically M pixels. For each of these pixels, the MTX circuit 42 in FIG. 4 generates Y, U, and V signals. Here M and N each represent an arbitrary integer of 2 or more; for example, M=480 and N=640.

The rotated image 72 is generated, likewise, as a two-dimensional image with (M×N) pixels arrayed in a matrix, and is composed of an array of horizontally N and vertically M pixels. Here, however, the horizontal and vertical directions of the rotated image 72 differ (are inclined by the rotation angle θ) from those of the original image 71. The image rotation portion 43 generates Y, U, and V signals for each of the pixels composing the rotated image 72.

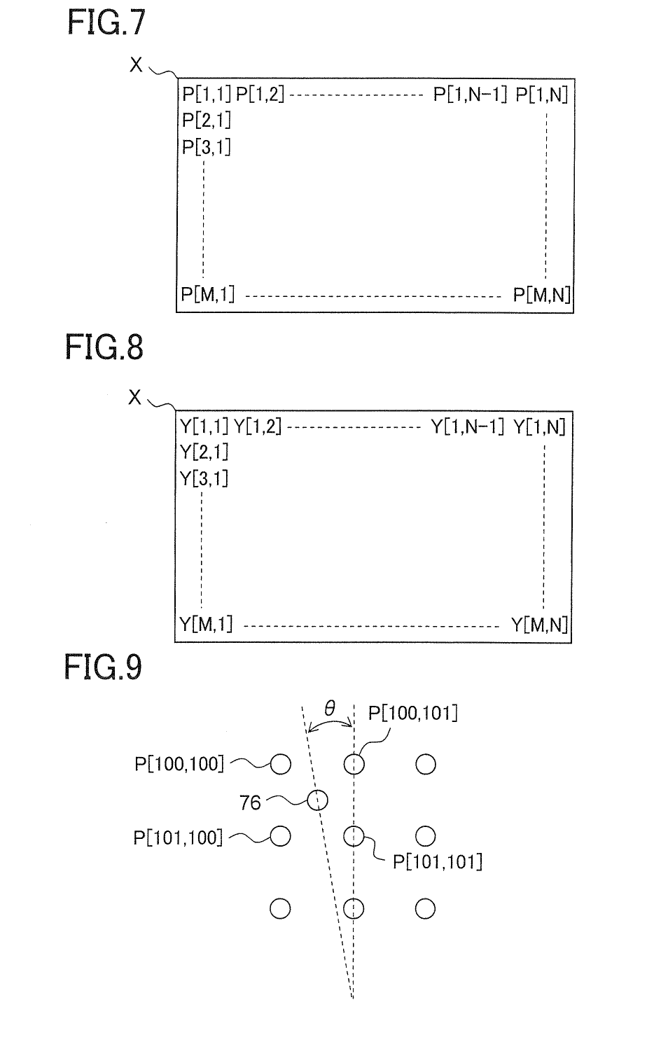

FIG. 7 shows the array of pixels composing the original image 71 or the rotated image 72. The array of pixels is taken as an M-row, N-column matrix with its reference point at the origin X of the image, and each pixel is represented by P[m, n]. Here, m is one of the integers in the range from 1 to M, and n is one of the integers in the range from 1 to N. On the other hand, FIG. 8 schematically shows the Y signals corresponding to the individual pixels P[m, n]. The value of the Y signal for pixel P[m, n] is represented by Y[m, n]. As Y[m, n] increases, the brightness of the corresponding pixel P[m, n] increases.

To calculate the Y, U, and V signals of each pixel P[m, n] of the rotated image 72, the image rotation portion 43 reads out the Y signals etc. of the original image 71—since these are necessary for the calculation—sequentially from the DRAM 17 along a scanning direction as indicated by the reference sign 75 in FIG. 6. By using the signals thus read out, the image rotation portion 43 then generates a rotated image 72.

For example, the Y, U, and V signals of each pixel P[m, n] of the rotated image 72 are calculated through interpolation processing or the like based on the Y, U, and V signals of the original image. More specifically, for example, in a case where, as shown in FIG. 9, a given pixel 76 of the rotated image 72 is located exactly at the center of the square formed by four pixels of the original image 71, namely pixels P[100, 100], P[100, 101], P[101, 100], and P[101, 101], the value of the Y signal of that pixel 76 is made equal to the average value of Y[100, 100], Y[100, 101], Y[101, 100], and Y[101, 101]. Needless to say, in a case where the pixel 76 is displaced from the center of the above-mentioned square, weighted average calculation is performed according to the amount of displacement. The U and V signals of the rotated image 72 are calculated in a similar manner as the Y signal.

### [Method for Calculation of Inclination Evaluation Value]

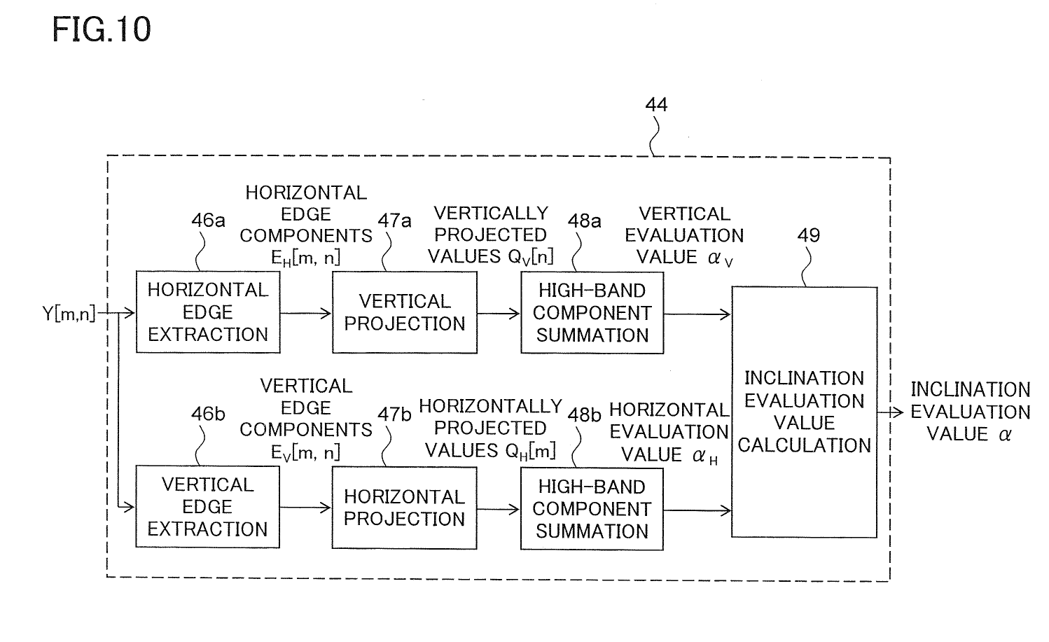

Next, the method by which the inclination evaluation portion 44 in FIG. 4 calculates an inclination evaluation value will be described. FIG. 10 is an example of an internal block diagram of the inclination evaluation portion 44. The inclination evaluation portion 44 of FIG. 10 is composed of: in a first part, a horizontal edge extraction portion 46a, a vertical projection portion 47a, and a high-band component summation portion 48a; in a second part, a vertical edge extraction portion 46b, a horizontal projection portion 47b, and a high-band component summation portion 48b; and in a third part, an inclination evaluation value calculation portion 49. The inclination evaluation portion 44 is fed with the Y signal of the rotated image or of the original image from the image rotation portion 43 or from the DRAM 17 or the like.

The inclination evaluation portion 44 handles the rotation image and the original image as “evaluation images” and, for each evaluation image, calculates an inclination evaluation value commensurate with the inclination of the evaluation image based on its Y signal. Here “inclination” means, as noted previously, the inclination of the vertical direction of an evaluation image relative to an “axis parallel to the plumb line” as assumed in the evaluation image.

Now the function of the inclination evaluation portion 44 in FIG. 10 will be described with attention paid to a given single evaluation image.

The horizontal edge extraction portion 46a extracts horizontal edge components (i.e. edge components in the horizontal direction) from the evaluation image. Here the extraction of horizontal edge components is performed pixel by pixel, and the horizontal edge component extracted with respect to pixel P[m, n] is represented by E_{H}[m, n].

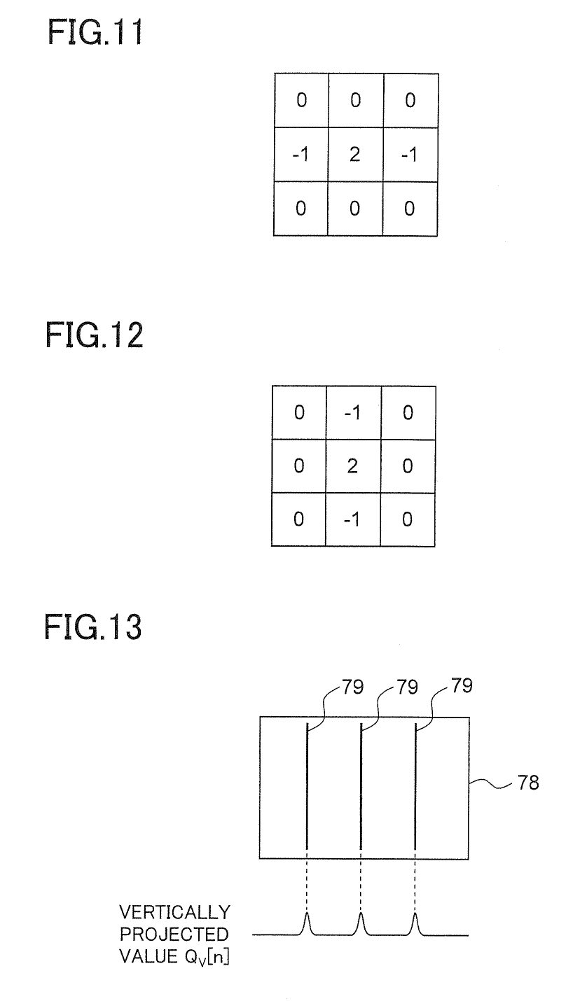

Extraction of a horizontal edge component is achieved by performing first-order differentiation or second-order differentiation on the input value to the horizontal edge extraction portion 46a. For example, extraction of a horizontal edge component is performed based on the Y signals of a pixel of interest and pixels neighboring it on the left and right by use of a filter as shown in FIG. 11. That is, in this case, when the pixel of interest is P[m, n], the horizontal edge component E_{H}[m, n] corresponding to it is calculated according to formula (1) below. The following description takes up, as a specific example, a case where, for each horizontal line, the instances where n is 1 and N are excluded and thus a total of (N−2) horizontal edge components E_{H}[m, n] have been calculated. This means that, in the evaluation image, (M×(N−2)) horizontal edge components have been calculated in the form of a matrix.

### [Formula 1]

E_{H}[m,n]=−Y[m,n−1]+2·Y[m,n]−Y[m,n+1] (1)

The vertical projection portion 47a projects the magnitudes (i.e. absolute values) of the horizontal edge components E_{H}[m, n] in the vertical direction, and thereby calculates, for each vertical line, a vertically projected value. When the vertically projected value of the vertical line corresponding to pixels P[1, n] to P[M, n] is represented by Q_{V}[n], the vertically projected value Q_{V}[n] is calculated according to formula (2) below. Specifically, the vertically projected value Q_{V}[n] is the sum of the absolute values of the horizontal edge components E_{H}[1, n] to E_{H}[M, n]. Since (N−2) horizontal edge components E_{H}[m, n] are calculated for each horizontal line, a total of (N−2) vertically projected values Q_{V}[2] to Q_{V}[N−1] are calculated.

$$\begin{matrix}[ Formula 2 ] & \\ {Q}_{V} [ n ] = {\sum }_{i = 1}^{M} \vert {E}_{H} [ i , n ] \vert & ( 2 )\end{matrix}$$

The high-band component summation portion (high-band component extraction/summation portion) 48a extracts the horizontal-direction high-band components of the vertically projected values Q_{V}[n] calculated one for each vertical line, and sums up the magnitudes (i.e. absolute values) of those high-band components, thereby to calculate a vertical evaluation value α_{V}.

Extraction of the horizontal-direction high-band component of a vertically projected value Q_{V}[n] is achieved, for example, by performing second-order differentiation on the vertically projected value Q_{V}[n] in the horizontal direction. For example, a filter as shown in FIG. 11 is used. Specifically, when the horizontal-direction high-band component of the vertically projected value Q_{V}[n] is represented by Q_{HPF}_{_{—}}_{V}[n], Q_{HPF}_{_{—}}_{V}[n] is calculated according to formula (3) below. In this case, since the total number of vertically projected values Q_{V}[n] is (N−2), a total of (N−4) high-band components Q_{HPF}_{_{—}}_{V}[2] to Q_{HPF}_{_{—}}_{V}[N−2] are calculated.

### [Formula 3]

Q_{HPF}_{_{—}}_{V}[n]=−Q_{V}[m,n−1]+2·Q_{V}[m,n]−Q_{V}[m,n+1] (3)

The high-band component summation portion 48a then sums up the absolute values of the calculated high-band components Q_{HPF}_{_{—}}_{V}[n], and thereby calculates the vertical evaluation value α_{V}. In a case where the number of high-band components is (N−4), the vertical evaluation value α_{V} is thus calculated according to formula (4) below.

$$\begin{matrix}[ Formula 4 ] & \\ {α}_{V} = {\sum }_{i = 3}^{N - 2} \vert {Q}_{HPF \_ V} [ i ] \vert & ( 4 )\end{matrix}$$

The function of the horizontal evaluation calculation portion composed of the vertical edge extraction portion 46b, the horizontal projection portion 47b, and the high-band component summation portion 48b is similar to the function of the vertical valuation calculation portion composed of the horizontal edge extraction portion 46a, the vertical projection portion 47a, and the high-band component summation portion 48a. The only difference is that, between the horizontal evaluation calculation portion and the vertical evaluation calculation portion, the horizontal and vertical directions are handled in place of each other.

The vertical edge extraction portion 46b extracts vertical edge components (i.e. edge components in the vertical direction) from the evaluation image. Here the extraction of vertical edge components is performed pixel by pixel, and the vertical edge component extracted with respect to pixel P[m, n] is represented by E_{V}[m, n]. The vertical edge extraction portion 46b calculates each vertical edge component E_{V}[m, n], for example, according to formula (5) below, which corresponds to a filter as shown in FIG. 12. In this case, in the evaluation image, ((M−2)×N) vertical edge components are calculated in the form of a matrix.

### [Formula 5]

E_{V}[m,n]=−Y[m−1,n]+2·Y[m,n]−Y[m+1,n] (5)

The horizontal projection portion 47b projects the magnitudes (i.e. absolute values) of the vertical edge components E_{V}[m, n] in the horizontal direction, and thereby calculates, for each horizontal line, a horizontally projected value. When the horizontally projected value of the horizontal line corresponding to pixels P[m, 1] to P[m, N] is represented by Q_{H}[m], the horizontally projected value Qₕ[m] is calculated according to formula (6) below. Specifically, the horizontally projected value Q_{H}[m] is the sum of the absolute values of the vertical edge components E_{V}[m, 1] to E_{V}[m, N].

$$\begin{matrix}[ Formula 6 ] & \\ {Q}_{H} [ m ] = {\sum }_{i = 1}^{N} \vert {E}_{V} [ m , i ] \vert & ( 6 )\end{matrix}$$

The high-band component summation portion (high-band component extraction/summation portion) 48b extracts the vertical-direction high-band components of the horizontally projected values Q_{H}[m] calculated one for each horizontal line, and sums up the magnitudes (i.e. absolute values) of those high-band components, thereby to calculate a horizontal evaluation value α_{H}. The vertical-direction high-band component of the horizontally projected value Q_{H}[m] is represented by Q_{HPF}_{_{—}}_{H}[m]. Q_{HPF}_{_{—}}_{H}[m] is calculated, for example, according to formula (7) below, which corresponds to a filter as shown in FIG. 12.

### [Formula 7]

Q_{HPF}_{_{—}}_{H}[m]=−Q_{H}[m−1,n]+2·Q_{H}[m,n]−Q_{H}[m+1,n] (7)

The high-band component summation portion 48b then sums up the absolute values of the calculated high-band components Q_{HPF}_{_{—}}_{H}[m], and thereby calculates the horizontal evaluation value α_{H}. In a case where the instances where m is 1, 2, (M−2), and M are excluded and thus the number of high-band components is (M−4), the horizontal evaluation value α_{H} is thus calculated according to formula (8) below.

$$\begin{matrix}[ Formula 8 ] & \\ {α}_{H} = {\sum }_{i = 3}^{M - 2} \vert {Q}_{HPF \_ H} [ i ] \vert & ( 8 )\end{matrix}$$

Referring to the vertical evaluation value α_{V} and the horizontal evaluation value α_{H}, the inclination evaluation value calculation portion 49 calculates an inclination evaluation value α commensurate with the inclination of the evaluation image according to formula (9) below. Here k_{V} and k_{H} are previously set coefficients, and their values are set with consideration given to the aspect ratio of the image. For example, in a case where M=480 and N=640, k_{V} and k_{H} are so set that k_{V}=3 and k_{H}=4. As will be described in detail later, variations are possible in which the inclination evaluation value α is represented by either the vertical evaluation value α_{V} or the horizontal evaluation value α_{H} alone.

### [Formula 9]

α=k_{V}·α_{V}+k_{H}·α_{H} (9)

Now, with reference to FIG. 13, what the vertical evaluation value α_{V} and the horizontal evaluation value α_{H} mean will be studied. Consider a case where, within a given evaluation image 78, there are a large number of brightness step edges 79 in the vertical direction (for the sake of simple illustration, only three step edges 79 are illustrated). The step edges 79 contain large horizontal edge components, and therefore, as shown in FIG. 13, the vertically projected values Q_{V}[n] corresponding to vertical lines along the step edges 79 have great values, and the vertically projected values Q_{V}[n] contain large high-band components in the horizontal direction. Accordingly, in this case, the vertical evaluation value α_{V} takes a relatively great value.

Needless to say, also in a case where there are a large number of edges other than step edges along the vertical direction, the vertical evaluation value α_{V} takes a great value. Likewise, in a case where there are a large number of edges along the horizontal direction, the horizontal evaluation value α_{H} takes a relatively great value.

When the field of view to the image shooting apparatus 1 is grasped as an image, the field of view usually contains a large number of edges parallel to the plumb line and to the horizon line. For example, when a building, a piece of furniture, a person standing erect, or the horizon line is grasped as an image, it contains a large number of edges parallel to the plumb line and (or) to the horizon line. On the other hand, a user frequently takes shots containing such edges. Accordingly, when an original image is rotation-corrected in the direction in which the vertical evaluation value α_{V} and (or) the horizontal evaluation value α_{H} increase, the inclination of the image should be corrected in the desired direction.

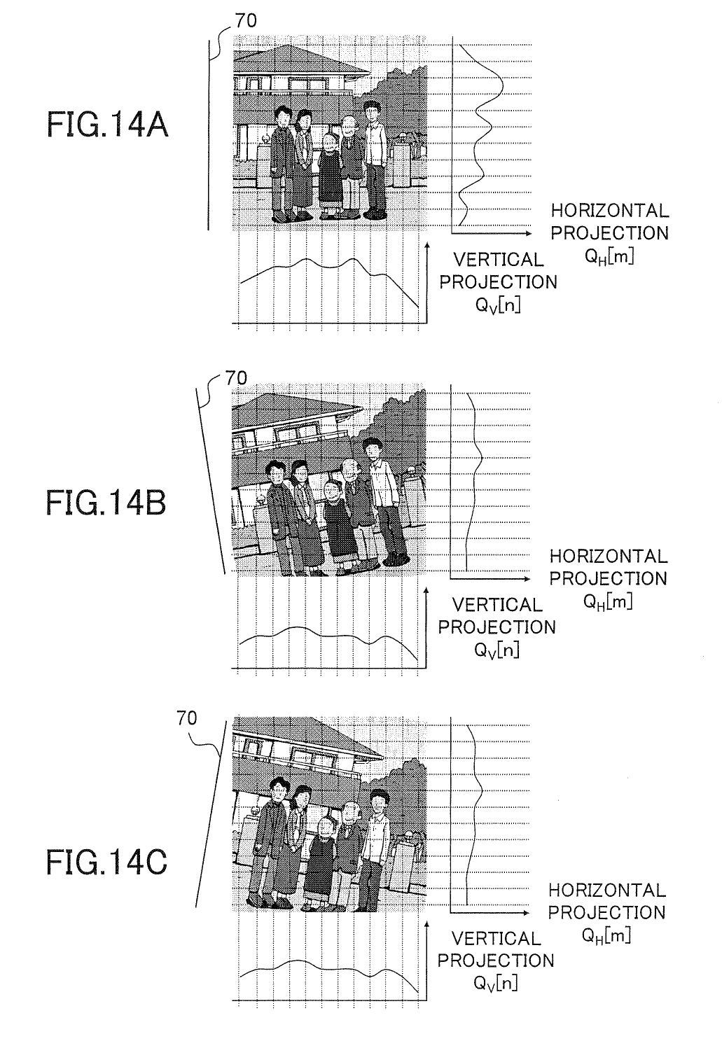

FIGS. 14A, 14B, and 14C show evaluation images obtained by rotation-correcting the same original image at different rotation angles, along with the corresponding vertically projected values Q_{V}[n] and horizontally projected values Q_{H}[m]. The vertical direction of the evaluation image shown in FIG. 14A is parallel to an axis 70 parallel to the plumb line as assumed in that evaluation image. In this case, as shown in FIG. 14A, the vertically projected value Q_{V}[n] has a great value, and contains a large high-band component in the horizontal direction; in addition the horizontally projected value Q_{H}[m] also has a great value, and contains a large high-band component in the vertical direction. Thus, the vertical evaluation value UV and the horizontal evaluation value α_{H} corresponding to the evaluation image shown in FIG. 14A have relatively great values.

On the other hand, the vertical direction of the evaluation images shown in FIGS. 14B and 14C is inclined relative to an axis 70 parallel to the plumb line as assumed in those evaluation images. Thus their vertically projected values Q_{V}[n] have small values, and contain small high-band components in the horizontal direction; in addition their horizontally projected value Q_{H}[m] also have small values, and contain small high-band components in the vertical direction. Thus, the vertical evaluation values α_{V} and the horizontal evaluation values α_{H} corresponding to the evaluation images shown in FIGS. 14B and 14C have relatively small values.

With attention paid to this fact, a rotated image as an inclination-corrected mage is obtained by rotation-correcting an original image in the direction in which the vertical evaluation value α_{V} which is commensurate with the magnitude of the high-band component of the vertically projected value Q_{V}[n] in the horizontal direction, increases, or in a direction in which the horizontal evaluation value α_{H}, which is commensurate with the magnitude of the high-band component of the horizontally projected value Q_{H}[m] in the vertical direction, increases, or in the direction in which they both increase. In practice, a rotated image as an inclination-corrected image is obtained by rotation-correcting an original image in the direction in which the inclination evaluation value α, which is calculated based on the vertical evaluation value α_{V} and (or) the horizontal evaluation value α_{H}, increases. The obtained inclination-corrected image is recorded to the memory card 18 via the compression processing portion 16 in FIG. 1, and is also displayed on the display portion 27.

Owing to the provision of the inclination correction function described above, a photographer can perform shooting without paying much attention to the inclination of the body (unillustrated) of the image shooting apparatus 1. This permits the photographer to concentrate on the following of the movement of the subject, and thus helps alleviate the load on the photographer.

The inclination evaluation value α can be calculated by many different modified methods other than that described above. Such modified methods will be described later and, now, the procedures for inclination correction operation in moving image shooting and in still image shooting will be described.

### [Procedure for Inclination Correction Operation in Moving Image Shooting]

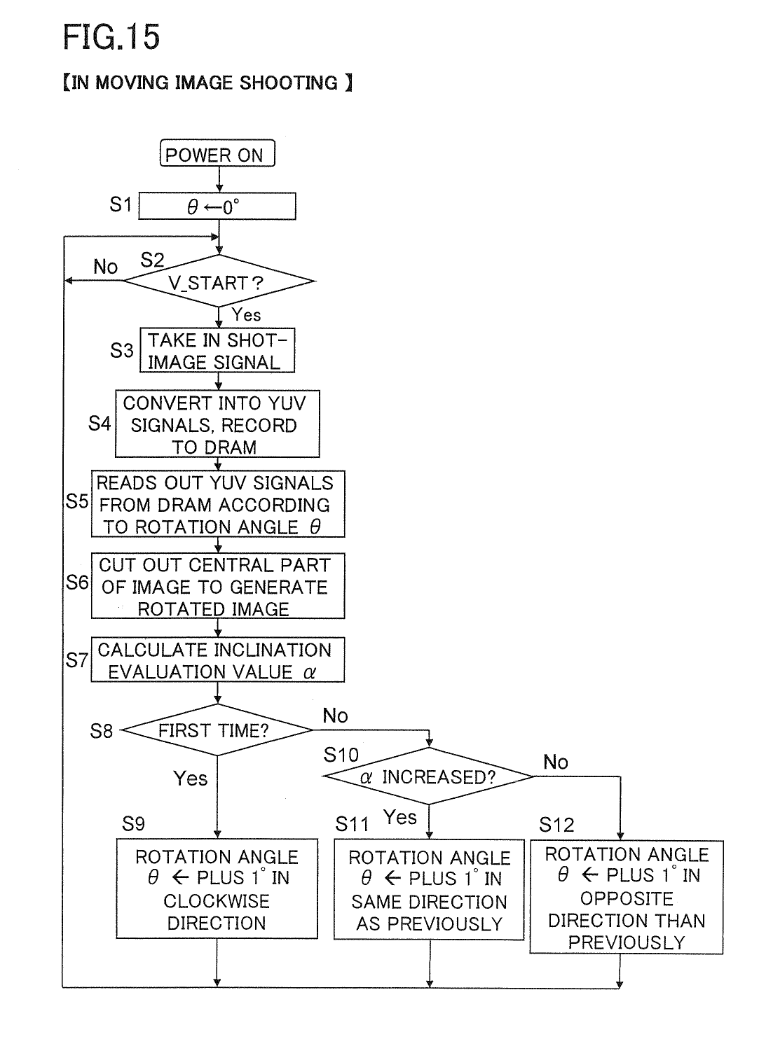

First, the procedure for inclination correction operation in moving image shooting will be described with reference to FIG. 15. The processing shown in FIG. 15 is performed only after moving image shooting is started at the press of the record button 26a in FIG. 1. The processing shown in FIG. 15, however, may be performed when moving image shooting is not being performed (e.g. in a state waiting for a request to start moving image shooting in shooting mode). In the following description, it is assumed that a rotation angle θ of a counter-clockwise rotation is negative, and that a rotation angle θ of a clockwise rotation is positive.

When a power switch (unillustrated) provided in the image shooting apparatus 1 is so operated as to start the supply of electric power to different blocks in the image shooting apparatus 1, as an initial value, 0° is substituted in the rotation angle θ (step S1), and the TG 22 starts to generate vertical synchronizing signals sequentially at a predetermined cycle (e.g. 1/60 seconds). In step S2, whether or not a vertical synchronizing signal is outputted from the TG 22 is checked. A vertical synchronizing signal is outputted from the TG 22 at the start of each frame. If a vertical synchronizing signal is outputted from the TG 22, an advance is made to step S3; if not, the processing in step S2 is repeated.

In step S3, the shot-image signal representing an original image is taken out of the AFE 12. Subsequently, in step S4, the shot-image signal is converted, via the color synchronization portion 41 and the MTX circuit 42, into Y, U, and V signals, which are then recorded to the DRAM 17.

Next, in step S5, the image rotation portion 43 reads out the Y, U, and V signals of the original image from the DRAM 17 according to the rotation angle θ. Then, in step S6, based on the Y, U, and V signals read out, a central part of the image obtained by rotating the original image through the rotation angle θ is cut out to generate a rotated image (corresponding to the image 72 in FIG. 5). The generated rotated image is outputted, as an inclination-corrected image, from the inclination correction portion 40 in FIG. 4 (the video signal processing portion 13 in FIG. 1), and this inclination-corrected image is, in moving image shooting, recorded to the memory card 18 via the compression processing portion 16.

Subsequently to step S6, in step S7, the inclination evaluation portion 44 handles the rotated image generated in step S6 as an evaluation image, and calculates the inclination evaluation value α for this evaluation image. After the processing in step S7, in step S8, whether or not this is the first time that an inclination evaluation value α is calculated through the processing in step S1 is checked. If this is the first time, an advance is made to step S9 (“Yes” in step S8), where the rotation angle θ is incremented by 1° in the clockwise direction. Thus, now, θ=1°. Thereafter, back in step S2, the processing from step S2 through step S8 is performed again.

If it is for the second or later time that an inclination evaluation value α is calculated through the processing in step S1 (“No” in step S8), an advance is made from step S8 to step S10, where the inclination evaluation value α calculated this time in step S7 is compared with that calculated last time. If the inclination evaluation value α this time is increased compared with the inclination evaluation value α last time, an advance is made to step S11 (“Yes” in step S10); if the former is decreased compared with the latter, an advance is made to step S12 (“No” in step S10).

Although not illustrated, in a case where the difference between the inclination evaluation value α this time and the inclination evaluation value α last time is equal to zero or equal to or smaller than a predetermined value, a return may be made to step S2 without performing the processing in step S11 or S12.

The rotation angle θ is changed every time step S9, S11, or S12 is gone through. In step S11, the rotation angle θ is incremented by 1° in the same direction as previously. For example, in a case where in step S9, S11, or S12 last time the rotation angle θ was incremented by 1° in the clockwise direction, in step S11 this time it is incremented by 1° in the clockwise direction. On completion of step S11, a return is made to step S2.

In step S12, the rotation angle θ is incremented by 1° in the opposite direction than previously. For example, in a case where in step S9, S11, or S12 last time the rotation angle θ was incremented by 1° in the clockwise direction, in step S12 this time it is incremented by 1° in the counter-clockwise direction. On completion of step S12, a return is made to step S2.

Through the above-described control of the rotation angle θ, the inclination evaluation value α corresponding to the inclination-corrected image generated for every frame is kept in the neighborhood of its maximum value. That is, so-called hill-climbing control on the inclination evaluation value α is achieved. In this way, an inclination of a shot image resulting from an inclination of the body (unillustrated) of the image shooting apparatus 1 is automatically corrected.

The processing from step S8 through S12 is performed, for example, by the CPU 23 in FIG. 1, or by the inclination correction portion 40 in FIG. 4, or by them both. A restriction may be imposed on the range in which the rotation angle θ may be changed. For example, a restriction is imposed on the range in which the rotation angle θ may be changed such that −10°≦θ≦10° always holds. In this case, if performing the processing in step S11 or S12 leads to unfulfillment of −10°≦θ≦10°, the above-described processing is inhibited in step S11 or S12 so that the rotation angle θ is kept unchanged from its previous value (−10° or 10°).

### [Procedure for Inclination Correction Operation in Still Image Shooting]

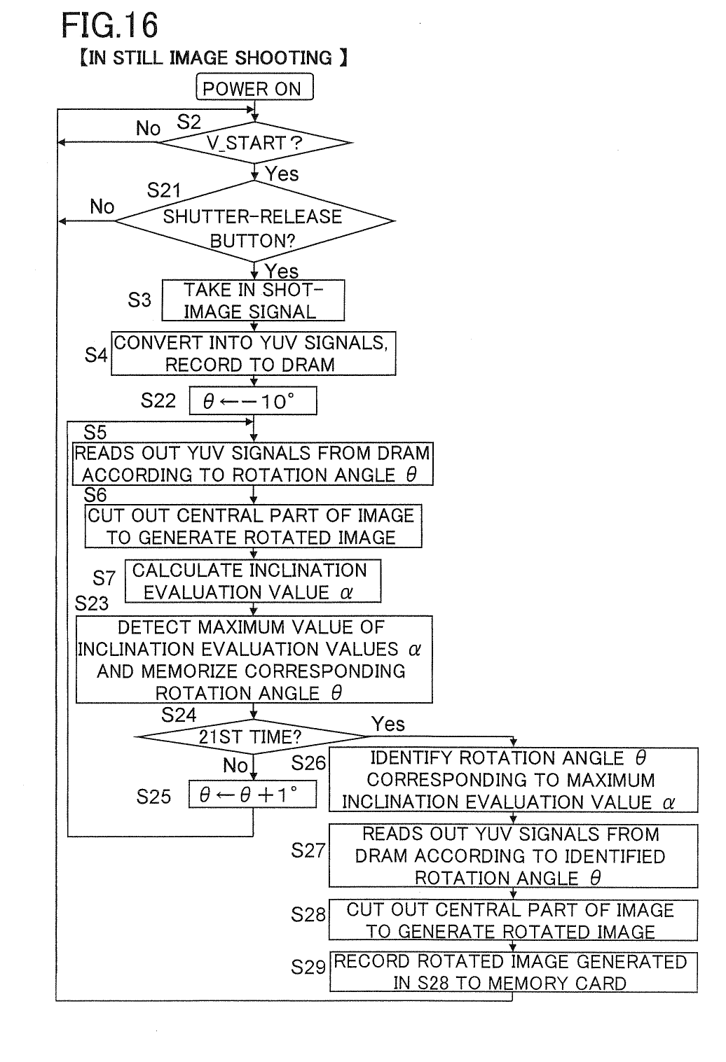

Next, the procedure for inclination correction operation in still image shooting will be described with reference to FIG. 16. Such steps identical with (or similar to) those described in connection with the procedure for inclination correction operation in moving image shooting are identified by common step numbers.

When a power switch (unillustrated) provided in the image shooting apparatus 1 is so operated as to start the supply of electric power to different blocks in the image shooting apparatus 1, the TG 22 starts to generate vertical synchronizing signals sequentially at a predetermined cycle (e.g. 1/60 seconds). In step S2, whether or not a vertical synchronizing signal is outputted from the TG 22 is checked. A vertical synchronizing signal is outputted from the TG 22 at the start of each frame. If a vertical synchronizing signal is outputted from the TG 22, an advance is made to step S21; if not, the processing in step S2 is repeated.

In step S21, whether or not the shutter-release button 26b in FIG. 1 is pressed is checked. If the shutter-release button 26b is pressed, an advance is made to step S3; if it is not pressed, a returns is made to step S2.

In step S3, the shot-image signal representing an original image is taken out of the AFE 12. Subsequently, in step S4, the shot-image signal is converted, via the color synchronization portion 41 and the MTX circuit 42, into Y, U, and V signals, which are then recorded to the DRAM 17.

Subsequently to step S4, in step 22, as an initial value, −10° is substituted in the rotation angle θ, and an advance is made to step S5. In step S5, the image rotation portion 43 reads out the Y, U, and V signals of the original image from the DRAM 17 according to the rotation angle θ. Then, in step S6, based on the Y, U, and V signals read out, a central part of the image obtained by rotating the original image through the rotation angle θ is cut out to generate a rotated image (corresponding to the image 72 in FIG. 5). As distinct from in moving image shooting, the rotated image generated here does not coincide with the inclination-corrected image outputted from the inclination correction portion 40 (in some cases, they eventually coincide).

Subsequently to step S6, in step S7, the inclination evaluation portion 44 handles the rotated image generated in step S6 as an evaluation image, and calculates the inclination evaluation value α for this evaluation image; then an advance is made to step S23.

Through the loop processing in steps S5, S6, S7, S23, S24, and S25 eventually 21 inclination evaluation values α are calculated for the same original image. In step S23, the current maximum value of the inclination evaluation values α is detected, and the rotation angle θ that gives that maximum value is memorized. After the processing in step S23, in step S24, whether or not the inclination evaluation value α has been calculated 21 times for the same original image is checked. Specifically, whether or not a total of 21 inclination evaluation values α corresponding to varying rotation angles θ in steps of 1° in the range of −10°≦θ≦10° have been calculated is checked.

If not all the 21 inclination evaluation values α have been calculated yet, an advance is made to step S25, where the rotation angle θ is incremented by a positive 1°, and a returns is made to step S5. By contrast, if all the 21 inclination evaluation values α have already been calculated, an advance is made to step S26.

In step S26, the rotation angle θ that has been memorized as the rotation angle θ that gives the inclination evaluation value α its maximum value in step S23 is identified as the rotation angle θ for inclination-corrected image generation, and an advance is made to step S27. For example, if, of the total of 21 inclination evaluation values α calculated for the same original image, the one at θ=+5° is the maximum value, the rotation angle θ for inclination-corrected image generation is set at +5°.

In step S27, according to the rotation angle θ for inclination-corrected image generation identified in step S26, the image rotation portion 43 reads out the Y, U, and V signals of the original image from the DRAM 17. Then, in step S28, based on the Y, U, and V signals read out in step S27, a central part of the image obtained by rotating the original image through the rotation angle θ for inclination-corrected image generation is cut out to generate a rotated image. The rotated image generated in step S28 is outputted as an inclination-corrected image from the inclination correction portion 40, and is recorded to the memory card 18 via the compression processing portion (step S29).

As described above, the rotation angle θ that gives the maximum inclination evaluation value α is calculated and, by use of the calculated rotation angle θ, a definite inclination-corrected image is generated as a still image to be recorded to the memory card 18. In this way, an inclination of a shot image resulting from an inclination of the body (unillustrated) of the image shooting apparatus 1 is automatically corrected.

The processing from step S23 through S26 is performed, for example, by the CPU 23 in FIG. 1, or by the inclination correction portion 40 in FIG. 4, or by them both. Although in the example described above the rotation angle θ is varied in the range of −10°≦θ≦10°, this range of variation may be changed freely.

### [Modified Examples of Method for Calculation of Inclination Evaluation Value]

Next, modified examples of the method for calculating the inclination evaluation value α will be described. Presented below as examples will be a first, a second, and a third modified calculation method.

### —First Modified Calculation Method—

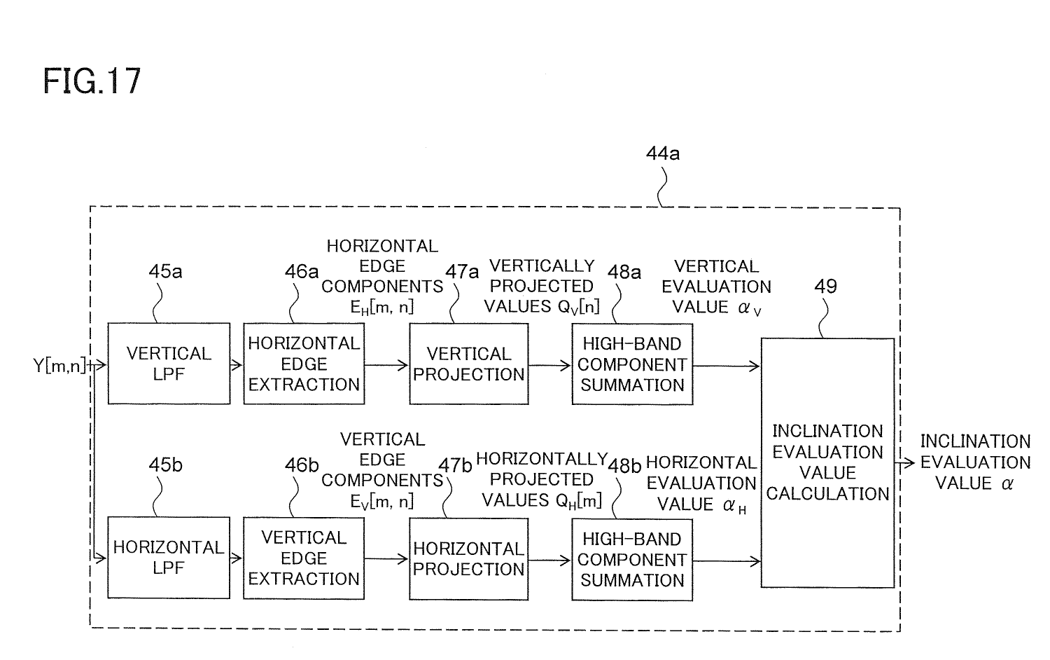

In the stage preceding the horizontal edge extraction portion 46a and the vertical edge extraction portion 46b shown in FIG. 10, an LPF (low-pass filter) for smoothing processing may be provided. This modified example will now be described as a first modified calculation method. An internal block diagram of an inclination evaluation portion 44a so modified is shown in FIG. 17. The inclination evaluation portion 44 in FIG. 4 may be replaced with the inclination evaluation portion 44a.

The inclination evaluation portion 44a differs from the inclination evaluation portion 44 of FIG. 10 in that a vertical LPF 45a and a horizontal LPF 45b are additionally provided in the stages preceding the horizontal edge extraction portion 46a and the vertical edge extraction portion 46b, respectively, in the inclination evaluation portion 44 of FIG. 10; otherwise they are identical. Accordingly, the following description concentrates on the function of the vertical LPF 45a and the horizontal LPF 45b.

The vertical LPF 45a performs spatial filtering in the vertical direction on the Y signal of each pixel of the evaluation image. The spatial filtering here is smoothing processing, whereby the vertical-direction low-band components of the Y signals of the evaluation image are extracted. When the pixel of interest for smoothing processing is represented by P[m, n], the Y signal Y_{VL}[m, n] after smoothing processing that is outputted from the vertical LPF 45a is calculated, for example, according to formula (10) below. Here, k₁, k₂, k₃, k₄, and k₅ are previously set coefficients.

$$\begin{matrix}[ Formula 10 ] & \\ {Y}_{VL} [ m , n ] = \frac{\begin{matrix}{k}_{1} \cdot Y [ m - 2 , n ] + {k}_{2} \cdot Y [ m - 1 , n ] + \\ {k}_{3} \cdot Y [ m , n ] + {k}_{4} \cdot Y [ m + 1 , n ] + {k}_{5} \cdot Y [ m + 2 , n ]\end{matrix}}{{k}_{1} + {k}_{2} + {k}_{3} + {k}_{4} + {k}_{5}} & ( 10 )\end{matrix}$$

The horizontal LPF 45b is similar to the vertical LPF 45a, the difference being that the horizontal LPF 45b performs spatial filtering in the horizontal direction.

Specifically, the horizontal LPF 45b performs smoothing processing in the horizontal direction on the Y signal of each pixel of the evaluation image, and thereby extracts the horizontal-direction low-band components of the Y signals of the evaluation image.

When the pixel of interest for smoothing processing is represented by P[m, n], the Y signal Y_{HL}[m, n] after smoothing processing that is outputted from the horizontal LPF 45b is calculated, for example, according to formula (11) below.

$$\begin{matrix}[ Formula 11 ] & \\ {Y}_{HL} [ m , n ] = \frac{\begin{matrix}\begin{matrix}{k}_{1} \cdot Y [ m , n - 2 ] + \\ {k}_{2} \cdot Y [ m , n - 1 ] + {k}_{3} \cdot Y [ m , n ] +\end{matrix} \\ {k}_{4} \cdot Y [ m , n + 1 ] + {k}_{5} \cdot Y [ m , n + 2 ]\end{matrix}}{{k}_{1} + {k}_{2} + {k}_{3} + {k}_{4} + {k}_{5}} & ( 11 )\end{matrix}$$

The vertical LPF 45a outputs the Y signals Y_{VL}[m, n] having undergone smoothing processing in the vertical direction to the horizontal edge extraction portion 46a, and the horizontal LPF 45b outputs the Y signals Y_{HL}[m, n] having undergone smoothing processing in the horizontal direction to the vertical edge extraction portion 46b. The horizontal edge extraction portion 46a handles the Y signals Y_{VL}[m, n] as Y[m, n], and calculates the horizontal edge components E_{H}[m, n] according to, for example, formula (1) noted previously. The vertical edge extraction portion 46b handles the Y signals Y_{HL}[m, n] as Y[m, n], and calculates the vertical edge components E_{V}[m, n] according to, for example, formula (5) noted previously.

Providing the vertical LPF 45a and 45b described above helps properly eliminate the noise components contained in the evaluation image, and helps enhance the accuracy of inclination correction.

### —Second Modified Calculation Method—

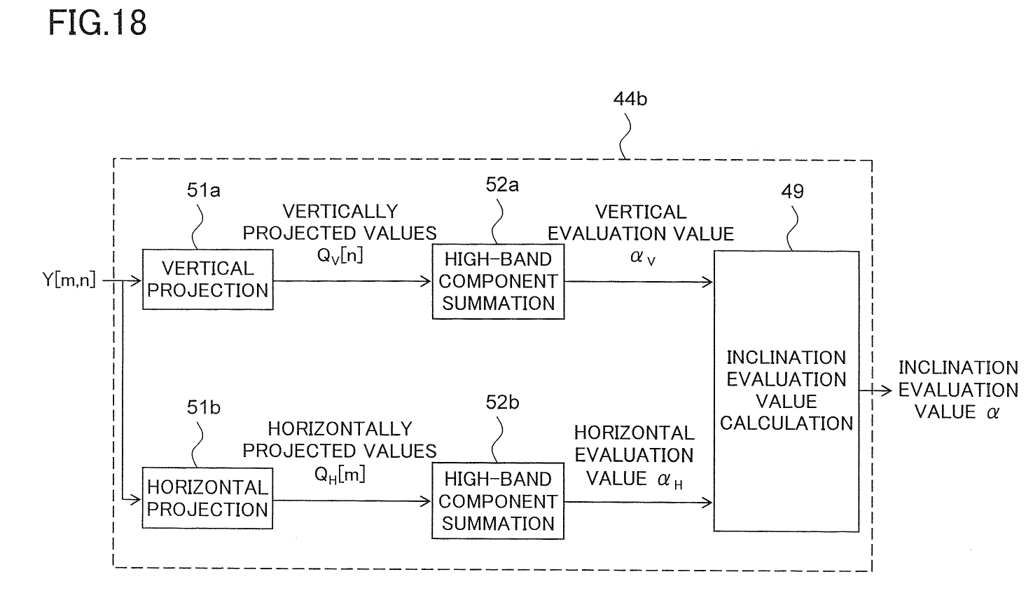

Next, as a second modified calculation method, another configuration of the inclination evaluation portion will be described. FIG. 18 is an internal block diagram of an inclination evaluation portion 44b for the second modified calculation method. The inclination evaluation portion 44 in FIG. 4 may be replaced with the inclination evaluation portion 44b.

The inclination evaluation portion 44b is composed of a vertical projection portion 51a, a horizontal projection portion 51b, high-band component summation portions 52a and 52b, and an inclination evaluation value calculation portion 49.

The vertical projection portion 51a projects the Y signals Y[m, n], i.e. brightness values, of the evaluation image in the vertical direction, and thereby calculates vertically projected values one for each vertical line. These vertically projected values are different from the vertically projected values calculated by the vertical projection portion 47a in FIG. 10 or 17; however, for the sake of convenience of description, the vertically projected values calculated by the vertical projection portion 51a are, like those calculated by the vertical projection portion 47a, represented by Q_{V}[n]. The vertical projection portion 51a calculates the vertically projected values Q_{V}[n] one for each vertical line according to formula (12) below. The calculated vertically projected values Q_{V}[n] are fed to the high-band component summation portion 52a.

$$\begin{matrix}[ Formula 12 ] & \\ {Q}_{V} [ n ] = {\sum }_{i = 1}^{M} \vert Y [ i , n ] \vert & ( 12 )\end{matrix}$$

The horizontal projection portion 51b projects the Y signals Y[m, n], i.e. brightness values, of the evaluation image in the horizontal direction, and thereby calculates horizontally projected values one for each horizontal line. These horizontally projected values are different from the horizontally projected values calculated by the horizontal projection portion 47b in FIG. 10 or 17; however, for the sake of convenience of description, the horizontally projected values calculated by the horizontal projection portion 51b are, like those calculated by the horizontal projection portion 47b, represented by Q_{H}[m]. The horizontal projection portion 51b calculates the horizontally projected values Q_{H}[m] one for each horizontal line according to formula (13) below. The calculated horizontally projected values Q_{H}[m] are fed to the high-band component summation portion 52b.

$$\begin{matrix}[ Formula 13 ] & \\ {Q}_{H} [ m ] = {\sum }_{i = 1}^{N} \vert Y [ m , i ] \vert & ( 13 )\end{matrix}$$

The function of the high-band component summation portions 52a and 52b is the same as the function of the high-band component summation portions 48a and 48b shown in FIG. 10 or 17. Specifically, for example, the high-band component summation portion 52a calculates the vertical evaluation value α_{V} according to formulae (3) and (4) noted previously, and the high-band component summation portion 52b calculates the horizontal evaluation value α_{H} according to formulae (7) and (8) noted previously. The inclination evaluation value calculation portion 49 in FIG. 18 is the same as that in FIG. 10 or 17.

In a case where there are step edges 79 as shown in FIG. 13 in the evaluation image, the vertically projected values Q_{V}[n] calculated by the vertical projection portion 51a contain large high-band components in the horizontal direction. The same is true with the horizontally projected values Q_{H}[m]. Thus, using the inclination evaluation portion 44b configured as shown in FIG. 18 achieves the same effect as described previously.

### —Third Modified Calculation Method—

Next, a modified example of the method for calculating the inclination evaluation value α in the inclination evaluation value calculation portion 49 in FIG. 10, 17, or 18 will be described as a third modified calculation method.

The description given previously with reference to FIG. 10 deals with a case in which the inclination evaluation value α is calculated according to formula (9) noted previously, and takes up, as a typical example, an example in which “in a case where M=480 and N=640, k_{V} and k_{H} are so set that k_{V}=3 and k_{H}=4”. This coefficient k_{V} may be set at a greater value (or the coefficient k_{H} may be set at a smaller value). For example, in a case where M=480 and N=640, k_{V} and k_{H} may be so set that k_{V}=5 and k_{H}=4. This increases the degree of contribution of the vertical evaluation value α_{V} to the inclination evaluation value α.

A user frequently performs moving image shooting etc. while panning or tilting the body (unillustrated) of the image shooting apparatus 1, in which case the vertical edge components (the horizontal evaluation value α_{H}) corresponding to edges along the horizontal direction changes relatively easily. This is because edges that are parallel to the horizon line in reality (e.g. the top and bottom sides of a window frame) do not appear parallel depending on the viewing angle and distance.

On the other hand, even in such a case, the horizontal edge components (the vertical evaluation value α_{V}) corresponding to edges along the vertical direction change little. That is, even with a slight change in the viewing angle and distance, edges that are parallel to the plumb line in reality (e.g. the left and right sides of a window frame) still appear parallel to the plumb line in the image. With this taken into consideration, the degree of contribution of the vertical evaluation value α_{V} to the inclination evaluation value α is increased. This is expected to enhance the accuracy of inclination correction.

Moreover, with the above circumstances taken into consideration, the vertical evaluation value α_{V} itself may be adopted as the inclination evaluation value α. In that case, the blocks for the calculation of the horizontal evaluation value a_{H} (the vertical edge extraction portion 46b in FIG. 10 etc.) may be omitted.

Contrary to the foregoing, in a case where, for example, it is previously known that a subject containing a comparatively large number of edges along the horizontal direction is going to be shot, the degree of contribution of the horizontal evaluation value α_{H} to the inclination evaluation value α may instead be increased. For example, in a case where M=480 and N=640, k_{V} and k_{H} may be so set that k_{V}=3 and k_{H}=5. Or the horizontal evaluation value α_{H} itself may be adopted as the inclination evaluation value α.

It is also possible to choose one of the vertical evaluation value α_{V} and the horizontal evaluation value α_{H} based on the result of comparison using the vertical evaluation value α_{V} and the horizontal evaluation value α_{H} and calculate, based on only the chosen one of those evaluation values, the inclination evaluation value α. For example, k_{V}·α_{V} and k_{H}·α_{H} are compared with each other. In a case where M=480 and N=640, for example, k_{V}=3 and k_{H}=4.

In a case where “k_{V}·α_{V}>k_{H}·α_{H}” holds, k_{V}·α_{V} (or α_{V} itself) is calculated as the inclination evaluation value α. In a case where “k_{V}·α_{V}>k_{H}·α_{H}” holds, the image contains relatively large horizontal edge components based on which the vertical evaluation value α_{V} is calculated. Accordingly, calculating the inclination evaluation value α based on the vertical evaluation value α_{V} corresponding to the horizontal edge components permits inclination correction to be performed with higher accuracy. By contrast, in a case where “k_{V}·α_{V}<k_{H}·α_{H}” holds, preferably k_{H}·α_{H} (or α_{H} itself) is calculated as the inclination evaluation value α.

In moving image shooting, the above-described comparison is performed every time the inclination evaluation value α is calculated (every time the processing in step S7 in FIG. 15 is gone through). It is also possible to choose one of the vertical evaluation value α_{V} and the horizontal evaluation value α_{H} when the above-described comparison is performed for the first time in the shooting of one moving image. In that case, until the shooting of the moving image is ended, the choice made is maintained (i.e. in the calculation of the inclination evaluation value α, the chosen one of the vertical evaluation value α_{V} and the horizontal evaluation value α_{H} is constantly used).

In the shooting of one still image, as described previously with reference to FIG. 16, a total of 21 inclination evaluation values α are calculated; here the total of 21 inclination evaluation values α corresponding to the same still image are calculated on the same basis. Specifically, for example, if, for a given still image, the vertical evaluation value α_{V} is chosen through the above-described comparison, all the 21 inclination evaluation values α corresponding to that still image are calculated based on the vertical evaluation value α_{V}. In still image shooting, the above-described comparison is performed, for example, with an original image (i.e. θ=0°) taken as an evaluation image, and to achieve this, the operation procedure shown in FIG. 16 is modified appropriately.

### [Other Modifications and Variations]

Unless inconsistent, the first, second, and third modified calculation methods described above may be combined together freely. Any specific value given in the above description is merely an example, and may be altered to any other value.

Although the inclination evaluation portion 44b in FIG. 18 is not provided with a block that directly extracts edges, the inclination evaluation value α calculated by the inclination evaluation portion 44b eventually reflects the horizontal edge components and (or) the vertical edge components. That is, the inclination evaluation portion 44b, like the inclination evaluation portions 44 and 44a, evaluates the inclination of the evaluation image based on the horizontal edge components and (or) the vertical edge components of the evaluation image, and outputs the result as the inclination evaluation value α.

As will be clear from the description above, irrespective of which of the inclination evaluation portions 44, 44a, and 44b is adopted, the inclination evaluation value α reflects the horizontal-direction high-band components of the horizontal edge components and (or) the vertical-direction high-band components of the vertical edge components of the evaluation image. The image shooting apparatus 1 of FIG. 1 performs rotation correction in the direction in which the magnitudes of those high-band components increase, and thereby produces an inclination-corrected image.

The inclination correction portion 40 alone, or the inclination correction portion 40 and the CPU 23 together, constitute an image inclination correction device.

The image shooting apparatus 1 of FIG. 1 may be realized in hardware, or in a combination of hardware and software. In particular, the function of the image inclination correction device described above, the function of the inclination correction portion 40 in FIG. 4, the function of the inclination evaluation portion 44 in FIG. 10, the function of the inclination evaluation portion 44a in FIG. 17, and/or the function of the inclination evaluation portion 44b in FIG. 18 may be realized in hardware, in software, or in a combination of hardware and software, and any of those functions may be realized outside the image shooting apparatus.

In a case where the function of the inclination correction portion 40 or of the inclination evaluation portion 44, 44a, or 44b is realized in software, FIGS. 4, 10, 17, and 18 serve as their respective functional block diagrams. All or part of the functions realized by the image inclination correction device described above may be prepared in the form of a software program so that this program is run on a computer to realize all or part of those functions.

In the inclination evaluation portion 44 of FIG. 10, the horizontal edge extraction portion 46a (horizontal edge component calculating portion), the vertical projection portion 47a, and the high-band component summation portion 48a constitute a vertical evaluation value calculating portion, and the vertical edge extraction portion 46b (vertical edge component calculating portion), the horizontal projection portion 47b, and the high-band component summation portion 48b constitute a horizontal evaluation value calculating portion. In the inclination evaluation portion 44a of FIG. 17, the vertical evaluation value calculating portion further includes the vertical LPF 45a (vertical smoothing portion), and the horizontal evaluation value calculating portion further includes the horizontal LPF 45b (horizontal smoothing portion). In FIG. 18, the vertical projection portion 51a and the high-band component summation portion 52a constitute a vertical evaluation value calculating portion, and the horizontal projection portion 51b and the high-band component summation portion 52b constitute a horizontal evaluation value calculating portion.

1. An image inclination correction device comprising:
an image rotating portion outputting a rotated image by changing an inclination of a shot image obtained by an image sensing portion; and
an inclination evaluating portion taking the rotated image as an evaluation image and evaluating an inclination of the evaluation image relative to a predetermined axis based on a shot-image signal representing the shot image,
wherein the image inclination correction device outputs, based on an evaluation result yielded by the inclination evaluating portion, an inclination-corrected image obtained by rotation-correcting the inclination of the shot image relative to the predetermined axis.

2. The image inclination correction device according to claim 1,
wherein the inclination evaluating portion evaluates the inclination of the evaluation image based on at least one of a horizontal edge component and a vertical edge component of the evaluation image.

3. The image inclination correction device according to claim 1,
wherein the inclination evaluating portion comprises:
a horizontal edge component calculating portion calculating horizontal edge components of the evaluation image in a form of a matrix; and
a vertically projecting portion projecting magnitudes of the calculated horizontal edge components in a vertical direction to calculate vertically projected values, and
wherein the image inclination correction device produces the inclination-corrected image by rotation-correcting the shot image in a direction in which magnitudes of horizontal-direction high-band components of the vertically projected values increase.

4. The image inclination correction device according to claim 1,
wherein the inclination evaluating portion comprises:
a vertical edge component calculating portion calculating vertical edge components of the evaluation image in a form of a matrix; and
a horizontally projecting portion projecting magnitudes of the calculated vertical edge components in a horizontal direction to calculate horizontally projected values, and
wherein the image inclination correction device produces the inclination-corrected image by rotation-correcting the shot image in a direction in which magnitudes of vertical-direction high-band components of the horizontally projected values increase.

5. The image inclination correction device according to claim 1,
wherein the inclination evaluating portion comprises:
a vertical evaluation value calculating portion comprising
a horizontal edge component calculating portion calculating horizontal edge components of the evaluation image in a form of a matrix, and
a vertically projecting portion projecting magnitudes of the calculated horizontal edge components in a vertical direction to calculate vertically projected values,
the vertical evaluation value calculating portion calculating a vertical evaluation value by summing up magnitudes of horizontal-direction high-band components of the vertically projected values; and
a horizontal evaluation value calculating portion comprising
a vertical edge component calculating portion calculating vertical edge components of the evaluation image in a form of a matrix, and
a horizontally projecting portion projecting magnitudes of the calculated vertical edge components in a horizontal direction to calculate horizontally projected values,
the horizontal evaluation value calculating portion calculating a horizontal evaluation value by summing up magnitudes of vertical-direction high-band components of the horizontally projected values, and
wherein the image inclination correction device determines the inclination-corrected image based on at least one of the vertical evaluation value and the horizontal evaluation value.

6. The image inclination correction device according to claim 1,
wherein the rotated image is formed as an image within a rectangular region lying inside the shot image before being rotated and having an aspect ratio commensurate with an aspect ratio of the shot image.

7. An image shooting apparatus comprising:
image sensing portion; and
the image inclination correction device according to any one of claims 1 to 6.

8. An image inclination correction method comprising:
taking as an evaluation image a rotated image obtained by changing an inclination of a shot image obtained by an image sensing portion, and evaluating an inclination of the evaluation image relative to a predetermined axis based on a shot-image signal representing the shot image, and
rotation-correcting, based on a result of the evaluation, the inclination of the shot image relative to the predetermined axis.

9. The image inclination correction method according to claim 8,
wherein the inclination of the evaluation image is evaluated based on at least one of a horizontal edge component and a vertical edge component of the evaluation image.
